(19) United States
(12) Patent Application Publication
(10) Pub. No.: US 2006/0214945 A1
(43) Pub. Date: Sep. 28, 2006

(54) Display device and display method

(75) Inventors: Takashi Nitta, Chino-shi (JP); Junichi Nakamura, Shiojiri-shi (JP); Shoichi Uchiyama, Shimosuwa-machi (JP); Tsunemori Asahi, Azumino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/386,926

(22) Filed: Mar. 23, 2006

(30) Foreign Application Priority Data
Mar. 23, 2005 (JP) 2005-083649

(51) Int. Cl. G09G 5/02

(52) U.S. Cl. 345/603

(57) ABSTRACT

A display device includes a luminance modulator and a color modulator which are formed of separate modulators. Herein, when, in order to reproduce an input signal, a luminance control signal of the luminance modulator and a color control signal of the color modulator are determined by the input signal, a three-dimensional look up table which is created on the basis of a measurement result relating to the color control signal corresponding to the predetermined luminance value is used, whereby the color control signal of the color modulator is determined by the input signal.

### BACKGROUND

1. Technical Field

The present invention relates to a display device suited to use in a HDR (High Dynamic Range) display which uses a two-modulation system, PTV (Projection TV), DTV (Digital TV), FPD (Flat Panel Display), and the like.

2. Related Art

In case of a two-modulation type display device, to the usual one-modulation system, another modulation system is connected optically in series. Therefore, the two-modulation type display device cannot deal with the usual one-modulation type color management. Therefore, a proposal as described below has been made.

The related art disclosed in Japanese Patent No. 3,523,170, relates to the two-modulation type, in which a modulation light source is used as one modulation system. Modulation of the light source is performed by combination of steady-state illumination by a cold cathode tube and modulated illumination by a white LED (Light Emitting Diode). Therefore, due to difference in emission spectrum between the cold cathode tube and the white LED, chromaticity of the source light changes in accordance with modulation. Its chromaticity change is formulated, using the following expression (2). Herein, an expression (1) is a conversion expression in a case that the steady-state illumination is performed by the cold cathode tube.
(X, Y, Z)′=M(R, G, B)′ (1)
(X, Y, Z)=M(R, G, B)′+gM′(R, G, B)′=N(R, G, B)′ (2)
N=M+gM′ (3)

Herein, R, G, B is a RGB (Red-Green-Blue) signal, X, Y, Z is a tristimulus value, M is 3×3 linear conversion matrix in a case that the steady-state illumination is performed by the cold cathode tube, M′ is 3×3 linear conversion matrix in a case that illumination is performed by the white LED, and g is a constant (gain=value determined by a luminance level of the white LED).

However, the expression (3) cannot deal with the case in which another modulator, for example, a liquid crystal panel changes in chromaticity in accordance with the modulation. Further, in a case that modulation is performed using a liquid crystal panel in place of the modulation light source, the change in chromaticity is nonlinear. Therefore, the change in chromaticity cannot be expressed simply by gM′ like the white LED in the expression (2).

Further, as general technology relating to the invention, in color management, conversion processing by a look up table in which plural sets of corresponding input and output values are previously stored is used in addition to operation processing which uses a conversion matrix. As the look up table, a three-dimensional look up table including three input elements, a one-dimensional look up table including one input element, or the like is used (Refer to, for example, JP-A-2001-203903 and JP-A-63-162248)

In the above related arts, in a case that a modulator such as the liquid crystal panel, which has characteristic that chromaticity changes nonlinearly in relation to modulation is used in the two-modulation type display device, there is a problem that it is difficult to obtain precise color reproducibility.

Further, in a case that we try to obtain the precise color reproducibility in the two-modulation type display device, processing taking plural characteristic elements into consideration is required. Therefore, in case that the number of the elements to be processed is simply increased, there can be a problem that the number of processing steps increases, or a circuit scale increases when the precise color reproducibility is realized by hardware such as LSI (Large Scale Integration).

### SUMMARY

An advantage of some aspects of the invention is to provide a display device and method in which precise color reproduction can be realized in two-modulation type color management by simple constitution.

According to an aspect of the invention, in a display device, a luminance modulator modulates luminance component, a color modulator modulates color component, a signal processing unit, when the signal processing unit determine a luminance control signal of the luminance modulator and a color control signal of the color modulator from a input signal, determine the color control signal by using a three-dimensional look up table which is created on the basis of a measurement result relating to the color control signal corresponding to the predetermined luminance value. According to this aspect, since use of the three-dimensional look up table makes the color conversion into easy processing, cost is reduced. Further, since a processing circuit for the three-dimensional look up table, which is generally used in a printer and the like, is applied, speed-up and cost reduction of the device can be realized.

Further, it is preferable that the signal processing unit determines independently the luminance control signal without using the three-dimensional look up table. Hereby, degree of freedom in processing on the luminance signal can be increased. Therefore, by determining the luminance signal more exactly, image quality can be improved without complicating the constitution.

Further, it is preferable that the signal processing unit including; a luminance determining unit determines the luminance control signal, the luminance determining unit including; a plurality of one-dimensional look up tables determines a plurality of the luminance signals corresponding to a respective elements included in an input signal, a maximum value determining unit receives output signals from the plurality of one-dimensional look up tables, and outputs a luminance signal having a maximum value of the plurality of luminance signals, the luminance signal having a maximum value being the luminance control signal. Hereby, by only adding the very simple circuit, processing can be performed, and speed-up and cost reduction of the device can be realized. Further, since accuracy is good, an advantage that image quality is good is readily obtained.

Further, it is preferable that: each grid point in the three-dimensional look up table holds a value of each element of the color control signal and a value of the luminance control signal; and both the luminance control signal of the luminance modulator and the color control signal of the color modulator are determined by the input signal, using this three-dimensional look up table. Hereby, processing is so ready that cost reduction can be readily realized. Further, since, for example, the existing processing circuit for four colors (CMYK (Cyan-Magenta-Yellow-Black)) can be applied, speed-up and cost reduction of the device can be realized very readily.

Further, it is preferable that a value in each table is determined by calculation using a matrix which represents a relation between each element of the input signal defined by individual color space in the display device and the color control signal. Hereby, even if all the grid points on the table are not actually measured, the table can be readily created.

Further, according to another aspect of the invention, in a projector comprising, a luminance modulator modulate luminance component, a color modulator modulate color component, a signal processing unit, when the signal processing unit determine a luminance control signal of the luminance modulator and a color control signal of the color modulator from a input signal, determine the color control signal by using a three-dimensional look up table which is created on the basis of a measurement result relating to the color control signal corresponding to the predetermined luminance value. According to this aspect, since use of the three-dimensional look up table makes the color conversion into easy processing, cost is reduced. Further, since a processing circuit for the three-dimensional look up table, which is generally used in a printer and the like, is applied, speed-up and cost reduction of the device can be realized.

Further, according to another aspect of the invention, in control of a display device in which a luminance modulator and a color modulator are formed of separate modulators, when, in order to reproduce an input signal, a luminance control signal of the luminance modulator and color control signal of the color modulator are determined by the input signal, a three-dimensional look up table which is created on the basis of a measurement result relating to the color control signal corresponding to the predetermined luminance value is used, whereby the color control signal of the color modulator is determined by the input signal.

### BRIEF DESCRIPTION OF THE DRAWINGS

The invention will be described with reference to accompanying drawings, wherein like numbers reference like elements.

FIG. 1 is a block diagram showing the constitution of a signal processing part in one embodiment of a display device according to the invention.

FIG. 2 is a block diagram of a HDR display as the display device in this embodiment.

FIG. 3 is a block diagram showing a constitutional example of a luminance determining part in FIG. 1.

FIG. 4 is a block diagram showing the constitution of a signal processing part in another embodiment of the display device according to the invention.

### DESCRIPTION OF EXEMPLARY EMBODIMENTS

One embodiment of the invention will be described below with reference to drawings. A display device in the embodiment is a two-modulation type display device which includes a color modulator and a luminance modulator separately. In the display device, a signal processing part for generating a control signal of each modulator or performing color management can be composed of a microprocessor system which incorporates hardware such as LSI and a software program to operate. However, a part or all of the signal processing part may be also composed of a general-purpose computer and a program in which processing of the invention is written.

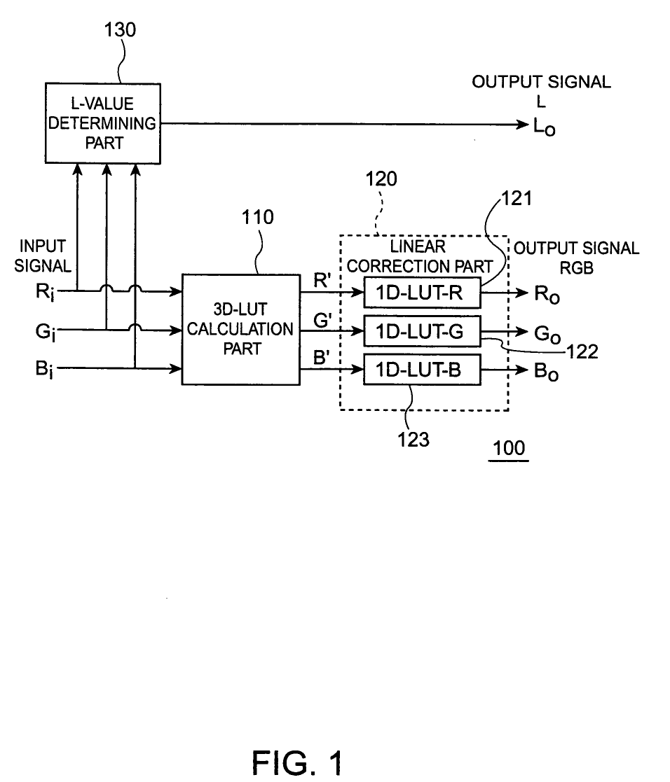

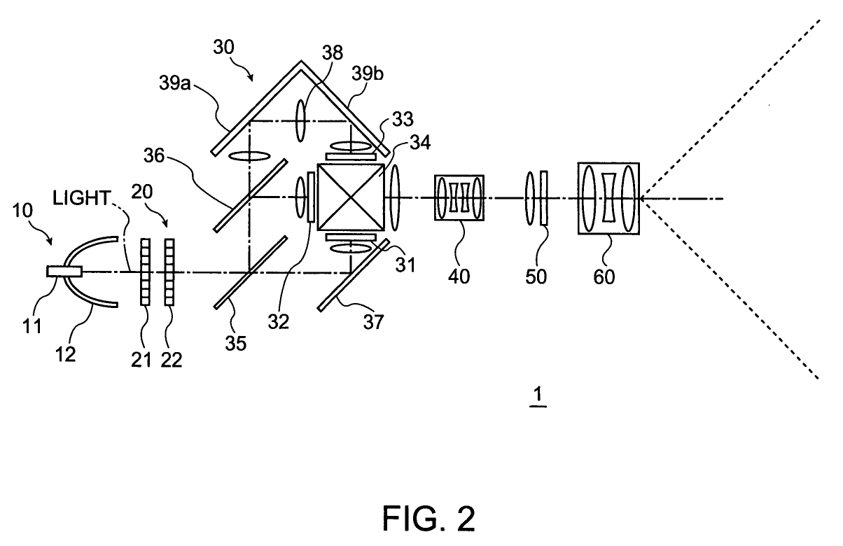

FIG. 1 is a block diagram showing a constitutional example of a signal processing part 100 in one embodiment of a display device according to the invention. FIG. 2 is a block diagram of a HDR display 1 as a constitutional example of the display device in this embodiment.

As shown in FIG. 2, regarding the constitution of each modulator in the HDR display 1 according to the embodiment and parts around each modulator, three-panel type liquid crystal color panel 31, 32, 33 (color modulator) in the front stage, and a single panel type liquid crystal luminance panel 50 (luminance modulator) in the back stage are optically connected in series by a relay lens 40. Even if a relation between the front stage and the back stage is reversed, the entirely similar processing can be performed. Regarding input to the liquid crystal panels, an 8-bit signal for each color (RGB), that is, a 24-bit signal in total is input to the color panels 31 to 33, and an 8-bit luminance signal is input to the luminance panel 50.

FIG. 2 shows the constitution of the HDR display 1 as an example of a projection type display device (projector). The HDR display 1 comprises a light source 10, an even illumination unit 20 which uniformizes luminance distribution of the light input from the light source 10, a color modulating part 30 which modulates each luminance of primaries (R, G, B) of the incident light from the even illumination unit 20, a relay lens 40 which relays the light input from the color modulating part 30, a liquid crystal luminance panel 50 which modulates the luminance in the whole wavelength region of the incident light from the relay lens 40, and a projection lens 60 which projects the incident light from the liquid crystal luminance panel 50 on a screen (not shown).

The light source 10 comprises a lamp 11 such as a high pressure mercury-vapor lamp, and a reflector 12 which reflects the light emitted from the lamp 11. The luminous flux emitted from the light source 10 is uniformized by the even illumination unit 20 in which a first fly-eyes lens 21 and a second fly-eyes lens 22 are in order arranged.

The light emitted from the even illumination unit 20, in which polarization is even, is incident on the light modulating part 30, and separated into three primary colors (R, G, B). The three primary color light receive modulation by the liquid crystal color panels 31, 32, and 33 which modulate their color component. The modulated three primary color (R, G, B) light are synthesized by a cross dichroic prism 34, and emitted to the relay lens 40. Here, the liquid crystal color panel 31 forms an optical modulator for R-component, the liquid crystal color panel 32 forms an optical modulator for G-component, and the liquid crystal color panel 33 forms an optical modulator for B-component. A dichroic mirror 35 transmits light of R-component, and a dichroic mirror 36 transmits light of B-component. Further, for the liquid crystal color panel 31, a reflection mirror 37 is provided; and for the liquid crystal panel 33, a relay lens 38 and two reflection mirrors 39a and 39b are provided.

The modulation light emitted from the relay lens 40 is incident on the other liquid crystal luminance panel 50 to receive the second modulation. The liquid crystal luminance panel 50 modulates the luminance in the whole wavelength region of the incident light(luminance component), and its modulated light is emitted to the projection lens 60 and projected by the projection lens 60 on a not-shown screen. Thus, the respective optical modulators (liquid crystal luminance panel 50 and liquid crystal color panels 31, 32 and 33) arranged optically in series perform the modulation by the pixel, whereby a projection image is formed.

The signal processing part 100 of the HDR display 1 (display device) shown in FIG. 1 comprises a three-dimensional look up table (3D-LUT) calculation part 110 and a nonlinear correction part 120 which output a color control value that is a control value of the optical modulator (liquid crystal panels 31, 32 and 33), and a luminance determining part 130 which outputs a luminance control value (hereinafter referred to as a luminance value L) that is a control value of the luminance modulator (liquid crystal luminance panel 50). The three-dimensional look up table calculation part 110, referring to a three-dimensional look up table composed of plural reference points which are previously stored in the predetermined memory area correspondingly to three elements (three components) Rᵢ, Gᵢ, and Bᵢ of a RGB input signal, finds a value of each element R′, G′ and B′ of a linear output signal and output the value. The three-dimensional look up table is created on the basis of the measurement result having a signal value relating to a color control signal such as an input RGB signal corresponding to the predetermined luminance value L, a linear RGB signal and an output RGB signal as a parameter (the details will be described later.)

For example, in a case that each of Rᵢ, Gᵢ, and Bᵢ that are three elements of the input signal is 8-bits (256 values), assuming that all the values of the three elements have the reference points, data constituting the three-dimensional look up table has enormous amounts of data (2563 data). Therefore, only the reference point corresponding to the specified input value referred to as a grid point holds usually a value, and the value of the reference point between the grid points is generally obtained by interpolation using the values of the surrounding grid points. In the embodiment, each of Rᵢ, Gᵢ, and Bᵢ that are the three elements of the input signal is 8-bits (256 values), and only the grid points that take values 0, 32, 64, 96, 128, 160, 192, 224, and 255 in each of RGB, that is, only 9×9×9=729 grid points hold linear output signal R′, G′, B′ values. The value of a reference point between the grid points is obtained by interpolation using the values of eight grid points around its reference point. Memory capacity of the table data which is necessary in this case is, since, for one grid point, the capacity is RGB=8 bits×3=24 bits=3 bytes, is 729×3=2187 bytes in total.

As the interpolation method at the reference point between the grids, linear interpolation is frequently used because it is easy. Therefore, as the three elements for referring to the LUT, color space which is easy to be interpolated linearly is used. As an example of the color space, there is uniform color space such as Lab or Luv. However, by holding the corresponding relation between the input three elements and the grid point values in another one-dimensional table to perform the conversion, the three input elements may be not the linear color space or the uniform color space (this one-dimensional table has been described in, for example, JP-A-63-162248). Namely, by using a one-dimensional look up table (lD-LUT) corresponding to conversion from nonlinear data to linear data, the output value can be accurately obtained even by the linear interpolation. In the embodiment, if necessary, on each of the input signals Rᵢ, Gᵢ, and Bᵢ, the conversion by the one-dimensional look up table, which is not shown, may be performed.

Further, on the linear output signal R′, G′, B′ values obtained by the three-dimensional look up table calculation part 110, nonlinear correction is performed by the nonlinear correction part 120. Namely, on the respective linear output signal R′, G′, B′ values, the nonlinear correction is performed referring to one-dimensional look up tables (1D-LUD) 121, 122, and 123 that take linear characteristics of gamma and the modulator into consideration, whereby outputs Rₒ, Gₒ, and Bₒ that are color control signals of the color modulators (liquid crystal panels 31, 32, and 33) are obtained.

The linear interpolation of the three-dimensional look up table calculation part 110 is easier processing than the multiply and accumulation such as the matrix operation in a case that LSI is taken into consideration. Therefore, the scale of the LSI may be small. Further, to these processing by the three-dimensional look up table calculation part 110, a color processing LSI in the usual display device can be applied as it is. Therefore, the cost can be reduced more.

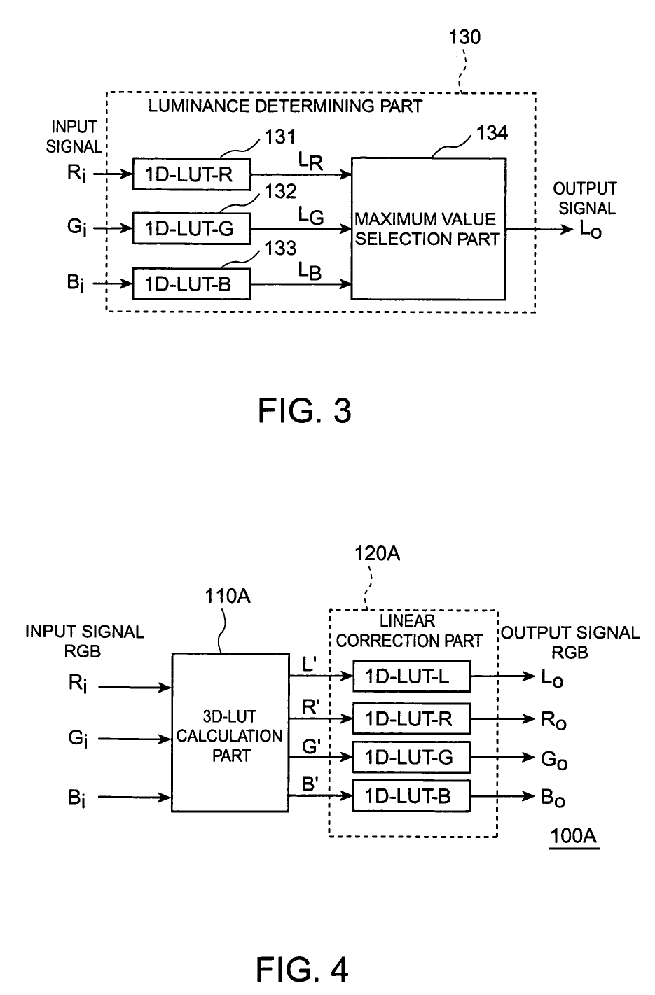

Next, processing by the luminance determining part 130 will be described with reference to a block diagram of FIG. 3. In FIG. 3, the luminance determining part 130 includes three one-dimensional look up tables (ID-LUT) 131, 132, and 133 corresponding to the three input signals Rᵢ, Gᵢ, and Bᵢ, and a maximum value selection part 134 which selects a maximum value from three output values of the one-dimensional look up tables 131, 132, and 133 and outputs the maximum value. The one-dimensional look up table 131, 132, and 133 are tables indicating respectively the corresponding relations between each of the input signals Rᵢ, Gᵢ, and Bᵢ and a luminance value L that is a control value of the luminance modulator (liquid crystal luminance panel 50) necessary to reproduce the corresponding input signal. Namely, luminance values L_{R}, L_{G}, and L_{B} individually corresponding to the respective RGB elements of the input signal are determined, and a maximum value of these three determination values is takes as an output signal Lₒ (=luminance control signal value L), whereby the color can be exactly reproduced.

Thus, in the embodiment, the luminance value L that is the control signal of the luminance panel (liquid crystal luminance panel 50) is, without using the three-dimensional look up table of the three-dimensional look up table calculation part 110, independently determined by the luminance determining part 130. Therefore, the degree of freedom in setting of the luminance value can be readily heightened. On the other hand, it is thought that the three-dimensional look up table of the three-dimensional look up table calculation part 110 includes a little error in the obtained color control value because of limitation of the reference value. However, in consideration of human visual characteristic that perceptibility on color is inferior to perceptibility on luminance, by setting exactly the luminance value determined by the luminance determining part 130, even if the color control value includes a little error, deterioration of image quality obtained lastly is kept very small.

Here, advantage of the constitution in which the luminance values L_{R}, L_{G}, and L_{B} corresponding to the respective RGB elements are found independently, and a maximum value of these three determination values is takes as an luminance control signal value L will be described compared with a method of determining a luminance value L in accordance with a luminance signal Y value. In a case that the method of determining an L-value in accordance with the luminance signal Y-value is adopted, the luminance signal Y-value is obtained by multiplying each value of RGB by weight in consideration of the human visual characteristic, as shown in an expression (4).
Y=0.7152×G+0.0722×B+0.2126×R (4)

Therefore, even in case that, for example, the B-value is large, the Y-value does not become too large. Assuming that the L-value is determined in accordance with the Y-value, the L-value does not become also too large. Namely, since display becomes dark, such display that only the B-value is large, that is, display of bright blue cannot be performed. Therefore, in the embodiment, using the constitution (method) shown in FIG. 3, the color can be reproduced exactly.

From a viewpoint of using the maximum value, a simple method of taking the maximum value of the input signals Rᵢ, Gᵢ, and Bᵢ as the L-value is also thought. However, in the embodiment, in order to compensate for color reproducibility of the liquid crystal luminance panel 50 for the input signal, nonlinearity of the input signal, and nonlinearity of the luminance panel, using the three one-dimensional look up tables 131, 132 and 133, compensation of their characteristics are performed.

Next, the constitution of the data stored in the three-dimensional look up table in the three-dimensional look up table calculation part 110 in FIG. 1 will be described. In the embodiment, each reference value corresponding to each grid point is not obtained by the direct measurement. Namely, on the basis of the predetermined measurement result, a three-dimensional matrix that represents a corresponding relation between RGB values of the input signal and R′, G′, B′ values of the linear output signal is founded, and by a result of the calculation using the three-dimensional matrix, the value of each grid point is obtained. According to this, compared the case where the value of the grid point is obtained by the direct measurement, the steps necessary to the measurement can be reduced particularly in case that the number of grids increases.

The matrix can be obtained as follows. Firstly, in an L-value (Herein, in case that the L-value is in a range of 0 to 255, the L-value is taken as 128.), actual display colors in four patterns Rₘₐₓ, Gₘₐₓ, Bₘₐₓ, and K, are measured by an absolute XYZ value. Namely, it is assumed that the four pattern measurement values are as follows: Absolute XYZ value of Rₘₐₓ=(X_{R}, Y_{R}, Z_{R}); Absolute XYZ value of Gₘₐₓ=(X_{G}, Y_{G}, Z_{G}); Absolute XYZ value of Bₘₐₓ=(X_{B}, Y_{B}, Z_{B}); and Absolute XYZ value of K=(X_{K}, Y_{K}, Z_{K}). Here, the Rₘₐₓ, Gₘₐₓ, and Bₘₐₓ are the RGB signals in which any one of RGB elements is largest, in which Rₘₐₓ=(255, 0, 0), Gₘₐₓ=(0, 255, 0), and Bₘₐₓ=(0, 0, 255). K is a RGB signal representing black, and K=(0, 0, 0).

The absolute XYZ value is the value of color which is represented using XYZ color space (chromatic system). In the invention, a method of representing the XYZ color space is divided into two kinds; absolute XYZ and relative XYZ. The absolute XYZ value is represented by digitizing color by tristimulus values XYZ in which Y is a luminance value (cd/m2). On the other, the relative XYZ value is obtained by digitizing color from the tristimulus values XYZ subjected to any normalization. In the relative XYZ, Y in the white point is usually normalized to a value of 100 or 1. Further, the XYZ color space is a CIE (Commission Internationale de I'Eclairage) standard chromatic system, in which color is represented by three values of Yxy, Y represents luminance, and xy represents chromaticity.

Further, in the color space by the absolute XYZ, the individual color can be specified to the device (display device). Therefore, in the color space, there is an advantage that color management is readily performed. As other color spaces capable of specifying individual color to the device, there are QMh, relative XYZ, Lab, JCh, Luv, and the like. However, the reason when the absolute XYZ is used in the embodiment is that: in case that the color space such as the Lab or the relative XYZ which performs normalization by a white point is used in a system such as a HDR display which can deal with and display a HDR image having very high luminance, since the white point is mapped to the maximum luminance value, the display can become very unnatural. Further, since the absolute value of luminance is also a very important element on reproduction of light that is a characteristic of the HDR, the embodiment uses the absolute XYZ as the color space used in measurement.

From the above values in the four patterns, the relation between R′, G′, B′ value of a linear output signal in case of L=128, and the absolute XYZ value in that case can be represented by the following expression (5).

$$( \begin{matrix}X \\ Y \\ Z\end{matrix} ) = ( \begin{matrix}{X}_{R}^{′} & {X}_{G}^{′} & {X}_{B}^{′} \\ {Y}_{R}^{′} & {Y}_{G}^{′} & {Y}_{B}^{′} \\ {Z}_{R}^{′} & {Z}_{G}^{′} & {Z}_{B}^{′}\end{matrix} ) ( \begin{matrix}{R}^{′} \\ {G}^{′} \\ {B}^{′}\end{matrix} ) + ( \begin{matrix}{X}_{K} \\ {Y}_{K} \\ {Z}_{K}\end{matrix} ) \qquad ( 5 )$$

Here, X′_{R}=X_{R}−X_{K}, Y′_{R}=Y_{R}−Y_{K}, Z′_{R}=Z_{R}−Z_{K}, X′_{G}=X_{G}−X_{K}, Y′_{G}=Y_{G}−Y_{K}, Z′_{G}=Z_{G}−Z_{K}, X′_{B}=X_{B}−X_{K}, Y′_{B}=Y_{B}−Y_{K}, and Z′_{B}=Z_{B}−Z_{K}.

On the contrary, from the expression (5), conversion from the absolute XYZ value to the linear output signal R′, G′, B′ value can be obtained by the following expression (6)

$$( \begin{matrix}{R}^{′} \\ {G}^{′} \\ {B}^{′}\end{matrix} ) = {( \begin{matrix}{X}_{R}^{′} & {X}_{G}^{′} & {X}_{B}^{′} \\ {Y}_{R}^{′} & {Y}_{G}^{′} & {Y}_{B}^{′} \\ {Z}_{R}^{′} & {Z}_{G}^{′} & {Z}_{B}^{′}\end{matrix} )}^{- 1} ( \begin{matrix}X - {X}_{K} \\ Y - {Y}_{K} \\ Z - {Z}_{K}\end{matrix} ) \qquad ( 6 )$$

Using these two expressions, the absolute XYZ value and the linear output signal R′, G′, B′ value can be mutually converted. Further, regarding other L-values, by similarly finding the conversion matrix and K-vector for each L-value, the absolute XYZ value and the linear output signal R′, G′, B′ value can be mutually converted.

The conversion from the input signal value Rᵢ, Gᵢ, Bᵢ to the absolute XYZ value can be performed by converting an input value RGB into a relative XYZ value on the basis of the predetermined conversion expression, and converting the relative XYZ value into an absolute XYZ value on the basis of the measurement result. By thus converting the input signal value Rᵢ, Gᵢ, Bᵢ into the absolute XYZ value, and substituting the absolute XYZ value into the expression (6), a linear output signal R′, G′, B′ value can be obtained. On the basis of these corresponding relations, a value of each grid point stored in the three-dimensional look up table in the three-dimensional look up table calculation part 110 can be obtained.

Next, referring to FIG. 4, another embodiment of the invention will be described. FIG. 4 is a block diagram showing another embodiment of the invention. In this embodiment, a signal processing part 100A corresponding to the signal processing part 100 of FIG. 1 comprises a three-dimensional look up table calculation part 110A including the function of the luminance determining part 130 of FIG. 1, and a nonlinear correction part 120A. A Grid point of a three-dimensional look up table in the three-dimensional look up table calculation part 110A holds not only linear output signal R′, G′, B′ values but also a linear output signal L′-value (linear signal of a luminance value L), so that not only the R′, G′, B′ values but also the L′-value are obtained by calculation using the three-dimensional look up table. In the nonlinear correction part 120A, four one-dimensional look up tables are set, which include not only one-dimensional look up tables for nonlinear conversion of the linear output signal R′, G′, B′ values but also a one-dimensional look up table for nonlinear conversion of the linear output signal L′-value.

By the constitution in FIG. 4, the output signal can be determined by the similar processing to the three-dimensional look up table calculation for four values of CMYK, which is used in the usual printer and the like. Therefore, the existing LSI processing can be used fully, and further the cost can be reduced. However, compared with the constitution in FIG. 1, though the constitution can be simplified, accuracy of the output value of the luminance value L can lower a little.

According to each embodiment of the invention, in the two-modulation type display device including the luminance modulator and the color modulator, the color management is performed using the three-dimensional look up table created on the basis of the measurement result relating to the color control signal corresponding to the predetermined luminance value L, whereby output signals Rₒ, Gₒ, Bₒ that are the color control signals of the color modulators (liquid crystal color panels 31, 32, 33) are determined from the input signal RGB. Therefore, the exact color display can be realized by a little resource (namely, the number of the operation and load on data preparation are small).

The embodiments of the invention are not limited to the above. For example, the following changes are appropriately possible: division or unification of the processing blocks; and change of the input bit number, the output bit number, or the bit number in the operation.

The relation between components in Claim and components in the embodiments is as follows: Luminance modulator: Liquid crystal luminance panel 50, Color modulator: Liquid crystal color panel 31, 32, 33. Three-dimensional look up table: Three-dimensional look up table used by three-dimensional look up table calculation part 110 or 110A, Luminance control value of luminance modulator: L-value, Input signal: Input signal Rᵢ, Gᵢ, Bᵢ, Control value of color modulator: Color control signal Rₒ, Gₒ, Bₒ, or each element R′, G′, B′ of linear output signal, Luminance determining unit: Luminance determining part 130, Maximum determining unit: Maximum selection part 134, and Matrix indicating relation between each element of input signal defined by individual color space in display device, and color control signal: Expressions (5) and (6).

The entire disclosure of Japanese Patent Application No.2005-083649, filed Mar. 23, 2005 is expressly incorporated by reference herein.

What is claimed is:

1. A display device comprising:
a luminance modulator modulates luminance component,
a color modulator modulates color component,
a signal processing unit, when the signal processing unit determine a luminance control signal of the luminance modulator and a color control signal of the color modulator from a input signal, determine the color control signal by using a three-dimensional look up table which is created on the basis of a measurement result relating to the color control signal corresponding to the predetermined luminance value.

2. The display device according to claim 1, the signal processing unit determines independently the luminance control signal without using the three-dimensional look up table.

3. The display device according to claim 2, the signal processing unit including;
a luminance determining unit determines the luminance control signal,
the luminance determining unit including; a plurality of one-dimensional look up tables determines a plurality of the luminance signals corresponding to a respective elements included in an input signal, a maximum value determining unit receives output signals from the plurality of one-dimensional look up tables, and outputs a luminance signal having a maximum value of the plurality of luminance signals, the luminance signal having a maximum value being the luminance control signal.

4. The display device according to claim 1,
each grid point in the three-dimensional look up table holds a value of each element of a color control signal and a value of a luminance control signal; and
both a luminance control signal of the luminance modulator and a color control signal of the color modulator are determined by the input signal, using this three-dimensional look up table.

5. The display device according to claim 1, a value in each table is determined by calculation using a matrix which represents a relation between each element of the input signal defined by individual color space in the display device and the color control signal.

6. A projector comprising:
a luminance modulator modulate luminance component,
a color modulator modulate color component,
a signal processing unit, when the signal processing unit determine a luminance control signal of the luminance modulator and a color control signal of the color modulator from a input signal, determine the color control signal by using a three-dimensional look up table which is created on the basis of a measurement result relating to the color control signal corresponding to the predetermined luminance value.

7. A display method of controlling a display device in which a luminance modulator and a color modulator are formed of separate modulators, wherein when, in order to reproduce an input signal, a luminance control signal of the luminance modulator and a color control signal of the color modulator are determined by the input signal, a three-dimensional look up table which is created on the basis of a measurement result relating to the color control signal corresponding to the predetermined luminance value is used, whereby the color control signal of the color modulator is determined by the input signal.
